(19) United States
(12) Patent Application Publication
(10) Pub. No.: US 2023/0264514 A1
(43) Pub. Date: Aug. 24, 2023

(54) Run one motor cycle and tires

(71) Applicant: Earl Gary, Tchula, MS (US)

(72) Inventor: Earl Gary, Tchula, MS (US)

(73) Assignee: Earl Gary, Tchula, MS (US)

(21) Appl. No.: 17/803,125

(22) Filed: Feb. 24, 2022

(51) Int. Cl. B60B 7/01

(52) U.S. Cl. CPC B60B 7/01

(57) ABSTRACT

The triangular wheel bar frame would be placed two feet just outward in front inner side of handlebars to give the rider a better straight away speed which is different then the motorcycle made today.

The run one handlebars would have two two inch screw in bolt holes to aligned the wheel bar frame would be placed on the lower inner sides of the handlebars to give the rider better control different then the motorcycle made today.

The run one motorcycle tires would be slightly rounder slanted inner wage edges on the sides a small part in the center of the tires with this lightweight body design it would allow the rider to have a easier way to control the motorcycle on leans and turns on the road with both tires designed evenly the same for better balance then the tires today.

The run one motorcycle aluminum iron triangular wheel bar frames would be two feet long from the distance and each bar frame would be weighing about three pounds heavy and placed slightly out from the handlebar area in the lower rear of the motorcycle.

The aluminum iron triangular wheel bar frame would be one foot long coming down in length on the side depth of the motorcycle front tire side area.

Both of the aluminum iron triangular wheel bar frame on each bar on the side of the frames would be four inches in circular length that would be securely align to the handlebars of the motorcycle in the rear.

The triangular wheel bar frame would be place inside the lower middle area of the handlebars and screwed in by a one foot four inch aluminum bolt screw in rod just inside the handlebar area just in the rear below the shock resistant shock bar of the top part of the handlebars motorcycle.

The triangle wheel bar frame would also be screwed securely at the very bottom of the handlebars in place with a one foot and four inches long aluminum screw in bolt rod to have it in the rear of the bottom of the handlebar.

The triangular wheel bar frame would be screwed together to the handlebars in the rear inner lower sides area of motorcycle by using two one foot and four inch long aluminum screw on bolt rods that would weigh two pounds of each bolt rods.

The aluminum screw bolt rods that would align the wheel bar frame to the motorcycle would be two inches from the circular side with screw on ridges around the bar to secure in place the wheel bar frame in the lower inner side of the handlebars in the rear.

The aluminum bolt rods that would secure the wheel bar frame in place would have four two inch aluminum circus screw on lugs that would be two inches on side depth to help stabilize the rods in place when you align the wheel bar frame to the center of the motorcycle handlebars in the lower part in the rear.

The one foot four inch long aluminum bolt rods of the wheel bar frame would be screwed in place starting from the outer sides of the lower ends of the handlebar in the rear areas of the motorcycle to help lock in place the wheel bar frame.

The triangular wheel bar frame would have five screw on departments each bar frame to help secure in place the tire shield guard and the rim plate of the motorcycle handlebars and to secure in place the wheel bar frame to the handlebars that's in the rear of the motorcycle.

The tires shield guard of the holes on the wheel bar frame the department holes would be two and a half inch place holes at the center top of the wheel bar frame it would be two inches apart from each other to house the tire shield guard that will be just above the tire of the triangular wheel bar frame attached to the handlebars.

Attached to the handlebars In the rear of the triangular wheel bar frame there would be the two two inch circular size screw in department holes on bars of the frame that would be placed on to the motorcycle handlebars just in the back.

In front of the aluminum iron wheel bar frame would be the seven inch in size circular rim plate department hole in front to align the seven inch rim plate to the wheel bar frame.

Just in the center top of the wheel bar frame would be the tire shield guard the tire shield guard would be one foot four inches long and weighing two pounds and made of aluminum iron and would be placed just above the tire that's align to the wheel bar frame attached to the motorcycle handlebars.

The side depth of the tire shield guard aligned to the wheel bar frame would be one foot long from the distance of the motorcycle wheel bar frame on the side of the front rim and tire area.

The tire shield guard would have two half inch screw on bolts on both sides that would be two inches in distance apart on the side and four inches long from the shield guard so you can align and secure the shield guard to the wheel bar frame that's above the motorcycle rim tire in front.

The handlebars of the run one motorcycle that would align the wheel bar frame would weigh ten pounds and would have two two inch circular round screw on department holes on both sides of the aluminum iron frame with two on both sides of the frame just below the shock resistant shock bar of the handlebars area.

At the very bottom of the aluminum iron run one motorcycle handlebars that would align the wheel bar frame to the motorcycle would be the two circular round two inch screw on departments holes on both sides so you would be able to screw on the two inch from the circular side for one foot and four inch long aluminum screw on bolt rods that would align the wheel bar frame securely to the run one motorcycle handlebars.

The wheel bar rotatable axle frame would securely be placed just inside the tire rims area in front of the motorcycle it would be a one foot two inch long aluminum bolt rod that also would weigh two pounds heavy and would have two half an inch circular incisions around the center middle part of the bar that would be five inches long from the distance of each other on the bar frame.

Then you would place on to the rotatable axle aluminum rod the two five inch long aluminum housing plates that would fit together around the center of the bar frame the aluminum plates would be half a inch from the circular side depth and two oz of each plate and when place the two together are on the bar it would spin in a round motion from the rim and tire in front of the motorcycle.

On the rotatable axle bar you would fit the two rotatable axle plates together on the aluminum rotatable axle bar frame the plates would be five inches long just to fit onto the circular incisions around the bar frame so then it would rotate in a 360 circular motion around the bar when you place on the rim and tire to the rotatable axle frame that's would be place in the front area of the motorcycle wheel bar frame.

The rotatable axle bar frame rod would be one foot two inches long aluminum bar frame and would have two screw on ridges on each side of the end of bar frame so you can screw on the lugs securely on the bar to help keep it in place on the wheel bar frame.

The rotatable axle bar frame from the circular side would be two inches in width so you would be able to screw on the lugs to secure it in place onto the wheel bar frame once you placed it inside the rim and tire in front of the motorcycle aligned to the wheel bar frame.

The rotatable axle bar aluminum lugs that would be screwed on the bar frame on both sides of the end would be two two inch lugs a inch in side depth the lugs would be screwed on in place to the rotatable axle bar frame to the wheel bar just inside the rim and tire of the motorcycle in front.

On the wheel bar frame you would screw on the two seven inches circular rim plate that would weigh one pounds heavy and would be placed on both sides of the frame the the rim plate would have five screw on departments holes around the center of the rim plates so you would screw on the seven inch bolts to the wheel bar frame.

In the center of the rim plate would be the two inch circular end rotatable axle bar department hole where you would screw on the aluminum two inch lugs to help secure it in place on the rotatable axle bar on the wheel bar frame.

The seven inch wheel bar frame rim plates would be one inch in width on the side and made of aluminum iron material and placed just outside of the frame of the wheel bar in front of the motorcycle on both sides.

The rim plates would be screwed in place by five seven inch long and about a inch in length on the circular side screw on bolts of align to the inch size aluminum lugs the aluminum bolts would be to screw into the rim plate housing holes around the sides of the rim to secure it on the wheel bar frame to it align to the motorcycle handlebars.

The run one motorcycle tires would be lightweight steel belted a radio motorcycle tire that would be built slightly round yet flatter to the ground surface and shape with slanted wage edges coming inward on the sides of the tires slightly wide across the center middle part of the body of the tire in width of diameter.

The run one motorcycle tire would also have a one inch center part in the middle of the tire body design while the front tire would be six to eight inches across body in diameter the rear tire would be nine to ten inches in size in diameter length across the center middle part of body of the tire.

The run one motorcycle tires would come off from the side of the ground three to four inches in vertical distance of the road while the front tire would be slightly smaller in size then the tire in the rear both tires would be evenly designed equally the same.

### BRIEF DESCRIPTION OF DRAWINGS

FIG. 1

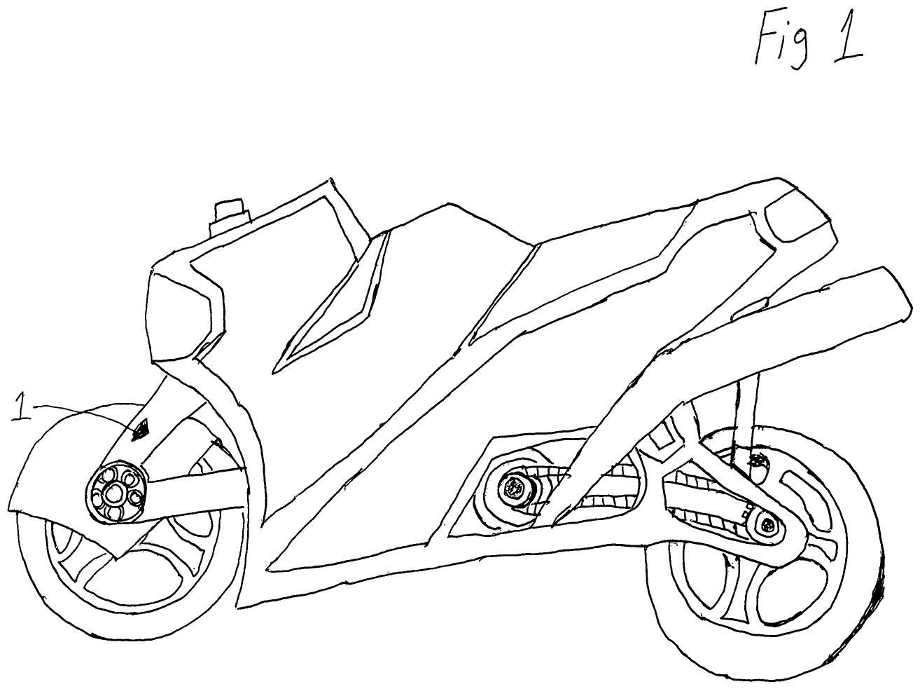

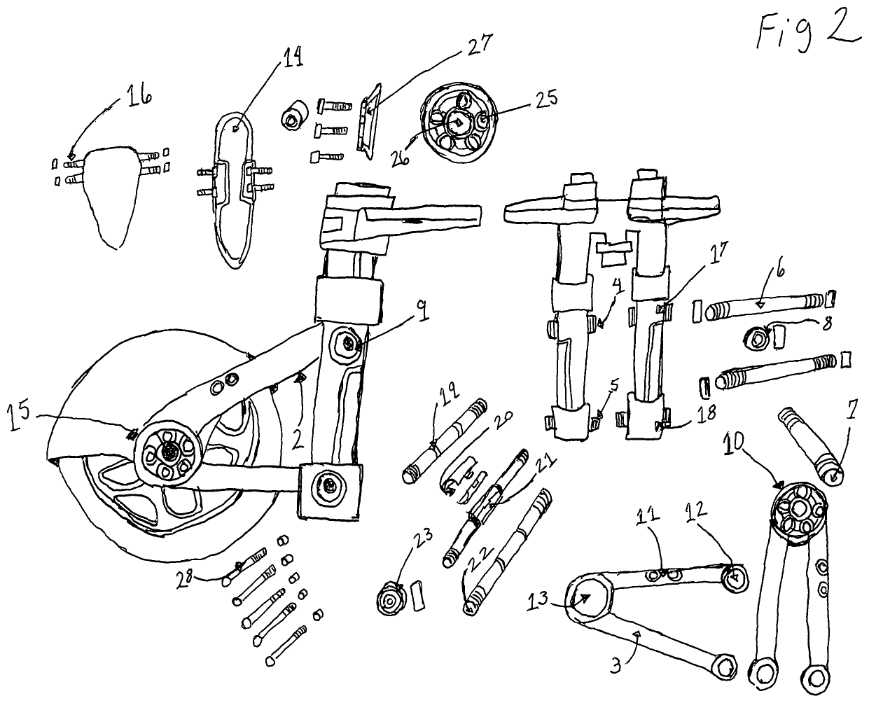

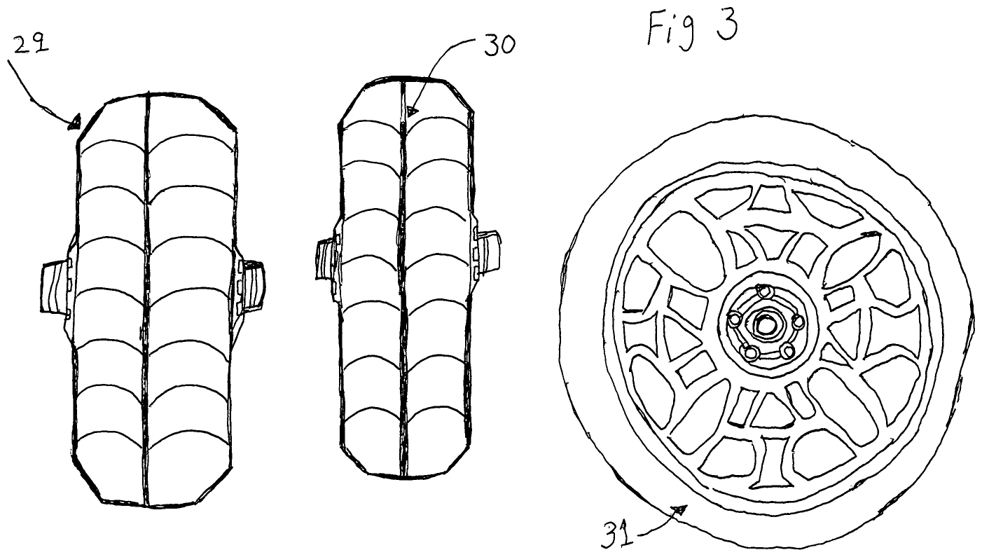

The aluminum iron triangular wheel bar frame of the Run One Motorcycle would extend two feet outward from the handlebars in the rear and weigh 3 lb of each bar frame and place in the center lower part of the handlebars of the motorcycle just below the shock resistant shock bar and at the very bottom with this design it would allow the rider to have a straightaway speed vantage over the road and overall agility in balance which is perfect for drift races and drag races with its lower position attached to handlebars in the rear it would be able to help the rider cut through the wind better then before then motorcycles previously made for better overall control.

### BRIEF DESCRIPTION OF DRAWINGS

FIG. 2

The aluminum iron triangle wheel bar frame of the run one motorcycle would be one foot in length of diameter from the side with its lower position attached to the handlebars in the rear it would be placed just below the shock resistant shock bar and at the very bottom of the handlebars in the rear which is just enough room to attach the tire in front and secure the tire shield guard just above the tire and to help secure the wheel bar frame to the handlebars of the motorcycle for overall balancing control while riding the motorcycle.

Both of the triangle The wheel bar frames of the motorcycle would be two feet long from the distance of the handlebars in the rear and each bar would be four inches in width on the sides of each bar frame with this length and size of the thick strong aluminum iron frame it would be able to give the motorcycle the ability to be put to the test of all the rider has to give it.

By placing the triangular wheel bar frame just inside the handlebars just below the shock resistant shock bar then having the wheel bar frame placed on the outside it would be able to secure the tire in place that's if the front tire would be about eight to nine inches in diameter in width it would be a better fit for the frames attached to tire in front with the one foot four inches long aluminum screw in rod that would help secured it in place in the rear of the handlebars.

At the very bottom of the rear the handlebars of the triangular wheel bar frame you would secure it in place to the handlebars for smoother stable ride by using a one foot and four inch long aluminum screw in rod to lock the frames securely in place on the handlebars on a motorcycle

The triangular wheel bar frame screw in aluminum rods would be one foot and 4 in Long and way two pounds each the rods will be attached to the wheel bar frame for a strong secure attachment to hold a frames in place to the handlebars.

The aluminum triangular wheel bar frame screw in rods would weigh two pounds and two inches in width on the circular side which makes it a strong sturdy bar frame that you would attach the bar frame to the handlebars in the rear so the rider can give the motorcycle all it has.

The aluminum bolt rods would be secured in place by four two inches from the circular width aluminum lugs that would also be two inches on the side in depth to help secure the wheel bar frame to the handlebars.

By placing the wheel bar frames on the inside of the handlebars just below the shock resistant bar in the rear and at the very bottom instead of placing the frames on the outside you would be able to attach the tire and the rim more securely in place better to the handlebars of the motorcycle by screwing in the aluminum one foot four inch long rods from the side of the motorcycle handlebars just in the rear to lock the wheel bar frame and place.

The triangular wheel bar frame would have five screw in the apartments on each frame to help secure the tire in front the shield guard just above the tire and to attach the handlebars to the wheel bar frame being a handlebars would be in the rear which is different than anybody made today.

The department holes on the wheel bar frame would be two and a half inches place holes at the center top of the frame the holes would be 2 in apart from each other on the bar frame to to secure in place the tire shield guard just above the tire by doing so you will secure the tire shield in place safely above the tire on the wheel bar frame.

To attach the wheel bar frame to the handlebars it would use two two inch circular screw in department holes that would be in the rear of each frames different and better than the motorcycles built today.

In front of the wheel bar frame would be the seven inches in circular width rim plate holes on the wheel bar frame to house the rim plate which is different than the motorcycles made today with one rim plate holes on each bar frame.

In the center top would be the tire shield guard that would be one foot four inches long and weight about two pounds with two Screw bolts on each side of The shield guard that would make the tire shield guard different than the tire Shields built today

On the side of the tire shield guard that's attached to the wheel bar frame would be one foot in length of the rim and tire of sides of the motorcycle to help protect the side the rim of the motorcycle.

The shield guard would have two half a inch bolts on each side of the both sides that will be two inches apart on each side of the shield guard different than the guards on the motorcycles made today.

The handlebars of the run one motorcycle would weigh about ten pounds have two two inch circular size screw in department holes on each side to holes two just below the shock resistant shock bar the top of the bar frame would help secure the tire shield guard and help stabilize the The bar frame just below the handlebar area which is different than the motorcycles made today

At the very bottom of the handlebars of the run one motorcycle would be also two two inch circular round screw in department holes to attach securely the wheel bar frame secure to the frame of the handlebars of the run one motorcycle which is different than a bikes made today.

The rotatable axle brain would be securely placed just inside the rim and tire area in front of the motorcycle in the wheel bar to fit securely in place to the wheel bar frame which is different than the bikes made today being that it would be 1 ft 2 in long and weigh 2 lb and in the center of the bar would be two half circular incisions around the bar frame that would be 5 inches apart of each other on the bar to secure in place the rotator plates that would align to the rim and tire.

The the run one motorcycle would have two 5 inch long rotatable axle plates with fit around the bar it will be 1 in in depth from the circular side to fit securely around the bar so it can rotate in a 360 rotation when you attach the rim and the tire to the bar frame which is different than a bikes made today.

5 inches long plates would fit around the 5 inch long incisions around the bar frame of the rotatable axle bar so then you would have the two aluminum plates together and secure them around the rotatable axle bar frame once you place the rim and tire around the rotatable plates that would be aligned to the rotatable axle frame it would spin in a 360 motion around the wheel bar frame just in front of the handlebars that will be placed in the rear which is different then the bikes made today.

Of the aluminum rotatable axle bar on each end of the bar would be two two inch from the circular side screw on ridges to help support the two two inch lugs that would be to screw on in place on each side to help secure the bar in place when attached to the rim and tire in the wheel bar frame different than the motorcycles made today.

The two inch and two in inches in depth from the side aluminum lugs of the rotatable axle bar frame would help secure the axle bar to the motorcycle wheel bar frame being that the wheel bar frame is a different way to design and build motorcycles today.

The rotatable axle bar aluminum lugs would be two inches on the side in depth small enough to fit securely around the rotatable axle bar frame large enough to be placed on to frame when you attach on the rim plate on the sides of the wheel bar frame would be placed just in the front of the motorcycle handlebars just in the rear.

On the sides of the the front of wheel bar frame would be the aluminum rim plates that would weigh 1 lb each and would fit on the side of the wheel bar frame when you attach the rotatable axle bar to the center of the rim and the tire which is a different style in making motorcycles today.

The 2-in circular hole align to the rim plate would be use when you attach on the rotatable axle bar frame to the rim and tire of the motorcycle then you would screw on the aluminum rim plates and in the center of the rim plate there would be a 2 inch circular round screw on hole on both rim plates so you can align the rotatable axle bar on each side on the ends of the bar frame different the motorcycles made today.

The 7-in aluminum rim plate would be 1 inch in depth from the side and the two plates would be secured on the sides of the wheel bar frame which is different than the motorcycles built today.

To help secure the rim plate to the wheel bar frame that would be 5 7 inch long aluminum bolts that would be an inch in circular depth from the screw on lug side in place onto the wheel bar frame which is different than the motorcycle is built today.

### BRIEF DESCRIPTION OF DRAWINGS

FIG. 3

The run one motorcycle tire would be a lightweight steel-budded radio motorcycle tire that would be slightly round yet flatter to the ground surface and with slanted wedge edges coming inward on the side of the tire slightly wide across the center middle part of the body of the tire in width of diameter with this by design which is more unique and different it would allow the rider to have weight shift on lanes and terms and be able to control the motorcycle without downshifting as much as before the slanted inward edges and a lightweight body it would grip the road with better balanced while riding the motorcycle.

Being the run one tire will be slightly wide with a small inch part in the center of the lightweight body design it would allow the rider to lean and turn with ease being that the tire would be in the front coming in and diameter of width of six to eight inches in the front and about in the rear about nine to ten inches it would allow the rider to have better control over the bike then before.

The run one motorcycle tire will come off the ground three to four inches and vertical distance and by being that both tires would be uniquely designed the same it would be easier to control the motorcycle then before with its wider yet slanted wedge edges on the side and the small part in the middle of this tire design you would be able to have even balance from the rear and to the front on straight always and on leans and turns evenly the same.

1-4. (canceled)

5. The triangular wheel bar frame would be 2 ft long and have five screw-on departments on the body frames.

6. The handlebars of the run one motorcycle would have two two inch screw department on both sides of the frame.

7. The run one motorcycle tire would be slightly wide round flatter to the ground body design with slanted wedge edges on the sides and a small inch part in the center of the lightweight steel belted radio tire.
